(19) United States
(12) Patent Application Publication
(10) Pub. No.: US 2007/0048719 A1
(43) Pub. Date: Mar. 1, 2007

(54) Methods and systems for presenting and recording class sessions in virtual classroom

(76) Inventors: Dahua He, Shanghai (CN); Yang Peng, Shanghai (CN); Sheng Jin, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/563,848

(22) PCT Filed: Jul. 6, 2004
(86) PCT No.: PCT/IB04/51134

§ 371 Date: Jun. 30, 2006

(30) Foreign Application Priority Data
Jul. 8, 2003 (CN) 03145833.5

(51) Int. Cl. G09B 3/00

(52) U.S. Cl. 434/350

(57) ABSTRACT

The present invention provides an improved distance learning solution. According to one embodiment of the invention, there provides a method for delivering a class session to students with client terminals in a virtual classroom. In this method, operations performed at a super client terminal in accordance with a teacher's actions are interpreted. The operations performed at the super client terminal includes presenting media objects selected by the teacher, that are prestored on a storage medium such as an optical disc. Then, relevant commands and parameters based on the teacher's actions are sent to client terminals to cause similar operations to be performed on the client terminals. In this way, the students' experience relating to presentation of the media objects at the clients terminals is controlled based on the operations performed at the super client. The whole class session in the virtual classroom including all the interactions among the class participants can be recorded and subsequently simulated.

### BACKGROUND OF THE INVENTION

The invention relates to distance learning technology and more particularly to methods and systems for presenting and recording class sessions in a virtual classroom.

Distance learning via TV and the Internet has been already used as an important alternative to live classroom education in schools. It provides great flexibility, allowing students to attend a class from their homes or other convenient locations without limiting the total number of students in the class. The class can be pre-recorded and played at different times to accommodate students with conflicting schedules. In the traditional distance learning technology, however, only limited interactions among the students and the teacher are possible. In some cases, e.g., classes offered via TV broadcasting, it is impossible to have any interactions among the class participants. In the cases where limited interactions are possible, it is difficult to record the whole class session including the interactions (e.g., chat messages) and video and audio programs and other comments inserted by the teacher. This causes difficulties for students who miss one of the class sessions and wish to view all the discussions occurred during the session. It causes similar difficulties for students who wish to review discussions relating to a particular topic in the class session.

Therefore, there is a need to provide an improved distance learning solution that allows class participants to have more interactions and allows the whole class session to be recorded and re-played.

### SUMMARY OF THE INVENTION

The present invention provides an improved distance learning solution that allows class participants to have more interactions and allows the whole class session to be recorded and subsequently simulated.

According to one embodiment of the invention, there provides a method for delivering a class session to students with client terminals in a virtual classroom. In this method, operations performed at a super client terminal in accordance with a teacher's actions are interpreted. The operations performed at the super client terminal includes presenting media objects selected by the teacher, that are pre-stored on a storage medium such as an optical disc. Then, relevant commands and parameters based on the teacher's actions are sent to client terminals to cause similar operations to be performed on the client terminals. In this way, the students' experience relating to presentation of the media objects at the clients terminals is controlled based on the operations performed at the super client.

In accordance with another embodiment of the invention, a method for recording a class session in a virtual classroom is provided. In this method, a reference is generated for each of selected media objects pre-stored on the storage medium, that is presented during the class session. The presentation information associated with each of the selected media objects is recorded. The presentation information includes timing information associated with presentation of each of the media objects during in the class session, such as start and stop time of the presentation. The presentation information may also include layout information associated with presentation of each of the media objects for specifying the relative position of the associated media objects on a display screen. Then, a table of contents is generated. The table of contents contains the references to the selected media objects and the associated presentation information so as to allow the class session to be subsequently simulated. Based on the table of contents, a corresponding file can be generated, that is executable to simulate the class session being presented. The corresponding file can be based on either the ECMA (European Computer Manufacturers Association) script or XML (Extensible Markup Language).

Other objects and attainments together with a fuller understanding of the invention will become apparent and appreciated by referring to the following description and claims taken in conjunction with the accompanying drawings.

### BRIEF DESCRIPTION OF THE DRAWINGS

The invention is explained in further detail, and by way of example, with reference to the accompanying drawings wherein:

FIG. 1 illustrates an overview of a WebDVD-based recordable virtual classroom model in accordance with one embodiment of the invention;

FIG. 2 is a flowchart diagram illustrates a process for initiating a class session in a virtual classroom using the WebDVD technology, in accordance with one embodiment of the invention;

FIG. 3 illustrates an exemplary display screen of a client terminal; and

FIG. 4 is a flowchart diagram illustrating a recording process for capturing an entire class session in a virtual classroom using a DVD player, in accordance with one embodiment of the invention.

Throughout the drawings, the same reference numerals indicate similar or corresponding features or functions.

### DETAILED DESCRIPTION OF THE PREFERRED EMBODIMENTS

The invention takes the advantage of the WebDVD technology to realize a virtual classroom. The WebDVD as defined by the DVD Forum (www.dvdforum.org) is a DVD-Video extension for linking a DVD-Video disc to the Internet. When a WebDVD disc containing links to websites is played in a DVD player, a user can gain new experience by combining the local DVD video contents with the enhanced contents on the Internet that are specifically related to this DVD disc. In a virtual classroom application, students can view the same video at the same time under the control of a teacher. The teacher controls the start, pause and stop time of all video shows on the students' display screen and can add comments and insert other streaming video and audio to each client's display screen. More details will be described below.

The invention then uses ECMA (European Computer Manufacturers Association) scripts or XML (Extensible Markup Language) such as the SMIL (Synchronized Multimedia Integration Language) to record all the events in a virtual classroom session. The SMIL language allows one to write interactive multimedia presentations with synchronized functions.

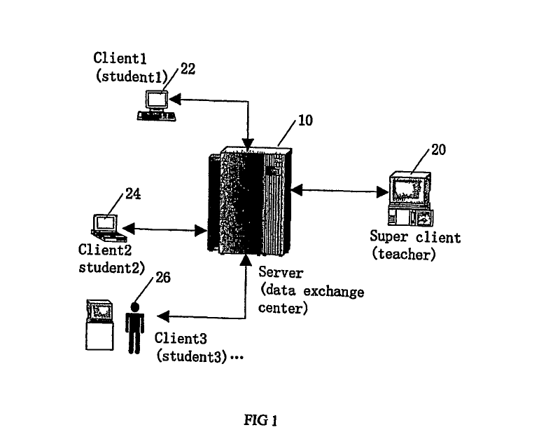

FIG. 1 illustrates an overview of a WebDVD-based recordable virtual classroom model in accordance with one embodiment of the invention. In FIG. 1, the virtual classroom is realized with a data exchange center 10, which can be implemented with a server. A super client 20, who is usually a teacher, runs virtual classroom applications on a super client terminal with privileges to control applications on the client terminals. A plurality of normal clients 22, 24, 26, etc., who are usually students in the virtual classroom, can interact with super client 20 via the Internet by running virtual classroom applications in their respective client terminals.

Before any session in the virtual classroom begins, a teacher prepares media objects (including audio, video, text, animation, etc.), also known as media assets, for a class, and then pre-stores these media objects on optical discs such as DVD or WebDVD discs. These discs are distributed to students. Then a server application of the virtual classroom is installed on the server at data exchange center 10. The server application provides the data exchange center functions for the teacher and the students. For example, the server application gathers and distributes chat text or audio, etc. It also executes commands to control students' experience, i.e., clients' behaviors, based on the teacher's operation, e.g., start or stop video or audio, show pictures, etc. Further, the server application controls the login and logout of the users. A super client application of the virtual classroom is installed on the teacher's terminal (e.g., a WebDVD player or a PC with a WebDVD driver). The super client application supports the teacher with a graphical user interface (GUI) for basic media operations, e.g., opening media files, starting or stopping videos and audios, and showing or removing pictures on the display screens. A normal client application of the virtual classroom is installed on each of the students' terminals (e.g., a WebDVD player or a PC with WebDVD driver). The normal client application traces and performs the teacher's operations on the client terminal in real time. It can also run recorded ECMA script-based or XML-based virtual classroom applications. Furthermore, it allows the normal client to interact with other class participants in real time by chatting, etc. All of the server application and the super and normal client applications can be implemented with Messenger-like software, e.g., Yahoo Messenger or RealPlayer software available from the Real Networks in the U.S.

To start a class session in the virtual classroom, the teacher, as super client 20, logs in virtual classroom server 10 with a WebDVD disc which stores the media objects. Students, as normal clients 22, 24, 26, etc., log in the virtual classroom server with the distributed WebDVD discs which store the media objects prepared by the teacher.

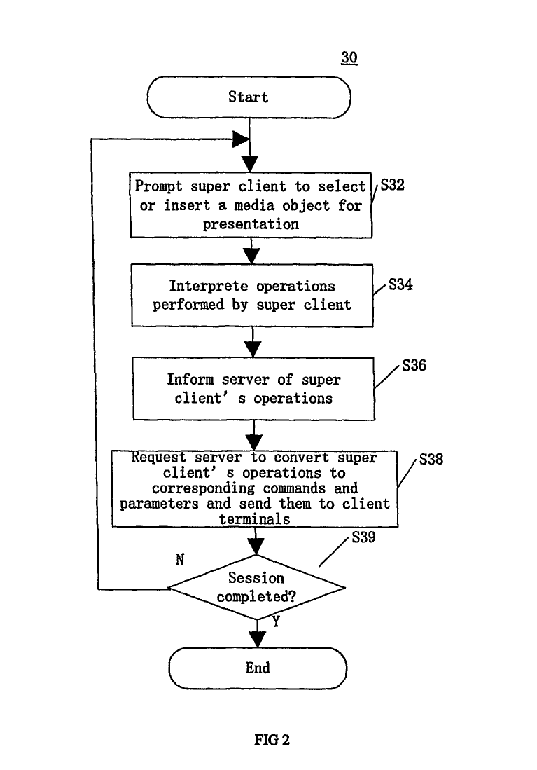

FIG. 2 is a flowchart diagram illustrating a process 30 for initiating a class session in a virtual classroom using the WebDVD technology, in accordance with one embodiment of the invention. In process 30, the super client (e.g., a teacher) is prompted to select or insert a media object for presentation (step S32). After the class session is started, the operations performed by the super client are interpreted (step S34), and the server is informed of these operations (step S36). The server is requested to convert the super client's operations to corresponding commands and parameter for sending them to the client terminals (step S38). Then, a determination of whether the class session is completed is made (step S39). If the session is not completed, steps S32, S34, S36 and S38 are repeated. Otherwise, the session ends.

By using process 30 in the virtual classroom, the teacher has full control of the media objects on the DVD discs distributed to the students, with GUI tools in the super client application that allow opening file menus and provide start and stop buttons, drag and drop functions, etc. The teacher can select and drag media objects and drop them in a video area for presentation on the display screen. The students' terminals are controlled and synchronized by the teacher's terminal, so that the teacher can control when, whether and how to present the media objects stored on the students' terminals. Real time chat based on text, audio, video, etc. can be done among the teacher and the students. The teacher can put text, images, video, etc. on the “white board” only for the teacher's use, while the students can write text on the “white board” for everyone participating in the virtual classroom. These white boards are defined in the server application. They can be in the designated areas or in pop-up sub-menus on a display screen.

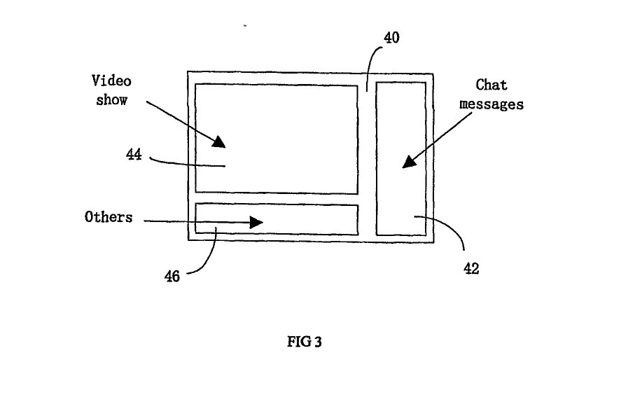

FIG. 3 illustrates an exemplary display screen 40 of a client terminal. Screen 40 includes a portion 42 for displaying chat messages, a portion 44 for displaying video shows, and a portion 46 for displaying other texts, e.g., textbook contents, notes, etc.

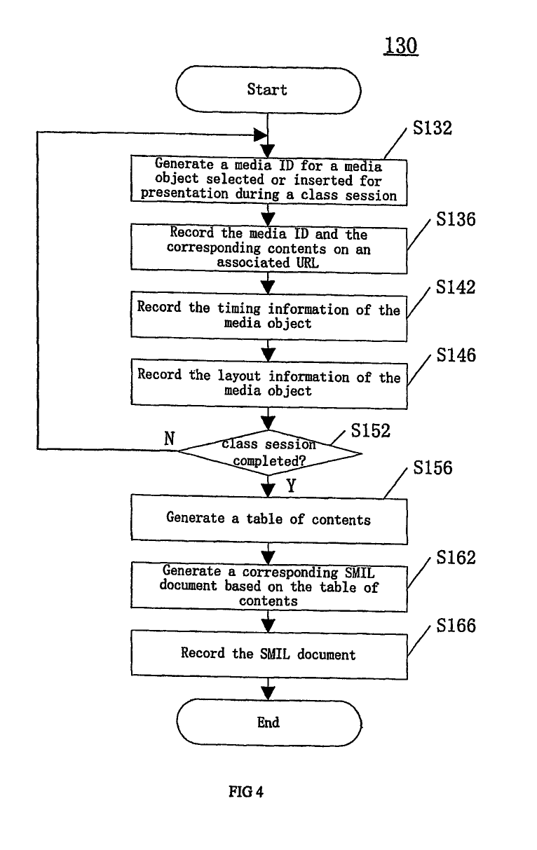

FIG. 4 is a flowchart diagram illustrating a recording process 130 for capturing an entire class session in a virtual classroom using a DVD player, in accordance with one embodiment of the invention. This recording process can be initiated by each class participant upon starting of the class session in the virtual classroom or at any time during the class session.

In recording process 130, after the recording function is initiated, a unique media identification (ID) is generated for a media object selected or inserted for presentation during the class session (step S132). As previously described, the media object may be pre-stored on the disc and presented by the teacher, or it may be a video, text, etc. inserted by the teacher. The media object may also be chat messages communicated among the students.

The media ID and the corresponding contents or only a reference, e.g., a uniform resource locator (URL), associated with this media object are recorded on an optical disc (step S136). The URL of a media object is recorded on the disc if the media object is not pre-stored on the disc. In the case of a chat message, it can be automatically recorded every a few seconds. The presentation information associated with the media objects being presented (including the timing and layout information) is also recorded on the disc. In particular, the timing information (i.e., the time stamps) including both the start and stop time information of the media object is recorded (step S142). The layout information of the media object (i.e., the position of the media object on the display screen) is recorded (step S146). The above relevant information including the media IDs, the URLs of the pre-stored media objects, the timing information, and the layout information may be temporarily written in the memory or hard disk of the player, from which they can then be written into the disc. Then, whether the class session has been completed is determined (step S152). If the session is not completed, steps S132, S136, S142 and S146 are repeated for each media object selected or inserted for presentation. After the class session is over, a table of contents is generated, listing the URLs of all the media objects presented during the class session in the virtual classroom (step S156). This table of contents captures the entire session in a chronological order and may be recorded on the disc. Thereafter, based on the table of contents, a corresponding SMIL document that describes the entire class session is generated (step S162) and is recorded (step S166). This SMIL document may also be written on a hard disk and can be subsequently run on PCs or on enhanced DVD players with Internet connections to simulate the entire class session.

In the above, if a student attends the class session in the virtual classroom without the WebDVD disc pre-stored with the media objects, the student can still record the class session on a storage medium (e.g., a computer hard disc or a blank DVD disc). The student can view all media objects presented by the teacher by streaming contents on the server in which the relevant media objects are stored, and record them. In such instances, all other steps illustrated in FIG. 4 are still performed in a similar manner.

Table 1 below shows an example of the table of contents. In Table 1, the teacher causes the media objects with media IDs 01, 02, 03, 04 and 05 to be presented during the class session. Among these media objects, the media objects with media IDs 03, 04 and 05 were pre-stored on the disc, while the media objects with media IDs 01 and 02 were inserted by the teacher during the class session. Media IDs 06, 07 and 08 are associated with chat messages, which were automatically recorded every a few seconds. Based on this table, the whole class session can be re-played in the same manner as it was originally presented. Thus, the media object with media ID 01, which is an image file, will start at zero minute, first second (0′1″) and end at zero minute, second second (0′2″) and will be presented in the image area of the display screen. The media object with media ID 02, which is an audio file, will start at zero minute, second second (0′2″) and end at first minute and zero second (1′0″), and so on.

TABLE 1
An Exemplary Table of Contents

| | | Start | | |
|---|---|---|---|---|
| Media ID | URL | time | Stop time | Region |
| 01 | demo.bmp | 0′1″ | 0′2″ | image_area |
| 02 | show.mp3 | 0′2″ | 1′0″ | |
| 03 | dvd://video/v1.mpeg2 | 1′0″ | 2′0″ | video_area |
| 04 | dvd://video/v2.mpeg2 | 2′0″ | 3′0″ | video_area |
| 05 | dvd://text/article1.txt | 3′0″ | 5′0″ | whiteboard_area |
| 06 | chat1.jpeg | 0′1″ | 0′2″ | chat_area |
| 07 | chat2.jpeg | 0′2″ | 0′3″ | chat_area |
| 08 | chat3.jpeg | 0′3″ | 0′4″ | chat_area |
| . . . | | | | |

The following is an example of a SMIL document generated based on the table of contents in Table 1.

```
<smil xmlns=“http://www.w3.org/2001/SMIL20/Language”>
  <head>
    <layout>
        ... other layouts
      <region id=”image_area” left=.. top=..height=.. width=... />
      <region id=”video_area” left=.. top=..height=.. width=... />
      <region id=”whiteboard_area” left=.. top=..height=.. width=... />
      <region id=”chat_area” left=.. top=..height=.. width=... />
      <region id=”whiteBoard_area” left=.. top=..height=.. width=... />
    </layout>
  </head>
  <body>
        ...
    <par>
      <img id=”01” src=”demo.bmp” region=”image_area” begin=”1s” end=”2s”/>
      <audio id=”02” src=”show.mp3” begin=”2s” end=”60s”/>
      <video id=”03” src=”dvd://video/v1.mpeg2” region=”video_area” begin=”60s” end=”120s”/>
      <video id=”04” src=”dvd://video/v2.mpeg2” region=”video_area” begin=”120s” end=”180s”/>
      <text id=”05” src=”dvd://text/article1.txt” region=”whiteBoard_area” begin=”180s” end=”300s”/>
      <seq>
        <img id=”06” src=”chat1.jpeg” region=”chat_area” begin=”1s” end=”2s”/>
        <img id=”07” src=”chat2.jpg” region=”chat_area” begin=”2s” end=”3s”/>
        <img id=”08” src=”chat3.jpg” region=”chat_area” begin=”3s” end=”4s”/>
      </seq>
    </par>
      ...
  </body>
</smil>
```

Thus, by using the present invention, students who missed the class and who wish to review the class can easily simulate the full class session with all the details. While the invention has been described in conjunction with specific embodiments, it is evident that many alternatives, modifications and variations will be apparent to those skilled in the art in light of the foregoing description. For example, other storage media such as flash memory, DVD discs, etc. may be used instead of WebDVD discs. Accordingly, it is intended to embrace all such alternatives, modifications and variations as fall within the spirit and scope of the appended claims.

1. A method for delivering a class session to students with client terminals in a virtual classroom, the method comprising the steps of:
(a) interpreting operations performed at a super client terminal in accordance with a teacher's actions; and
(b) sending relevant commands and parameters based on the teacher's actions to client terminals to cause similar operations to be performed on the client terminals;
wherein the students' experience relating to presentation of the media objects at the clients terminals is controlled based on the operations performed at the super client.

2. The method of claim 1, wherein the operations performed at the super client terminal includes presenting media objects selected by the teacher, that are pre-stored on a storage medium.

3. The method of claim 1, wherein the operations performed at the super client terminal includes presenting media objects provided by the teacher, that are not pre-stored on the storage medium.

4. The method of claim 1, wherein the students' experience is controlled through the controlling, by the teacher, of any of start, stop, and pause actions of the presentation of the media objects.

5. A method for recording a class session in a virtual classroom, comprising the steps of:
(a) recording selected media objects being presented during the class session;
(b) recording presentation information associated with each of the selected media objects being presented during the class session;
(c) generating a table of contents containing all of the selected media objects being presented during the class session, along with the associated presentation information so as to allow the class session to be subsequently simulated in a desired order based on the table of contents.

6. A method for recording a class session in a virtual classroom, comprising the steps of:
(a) generating a reference to each of selected media objects pre-stored on the storage medium, that is presented during the class session;
(b) recording presentation information associated with each of the selected media objects; and
(c) generating a table of contents containing the references to the selected media objects, along with the associated presentation information so as to allow the class session to be subsequently simulated based on the table of contents.

7. The method of claim 6, wherein the selected media objects include all of the media objects pre-stored on the storage medium.

8. The method of claim 6, further comprising a step of generating a reference to each of media objects being presented during the class session, that is not pre-stored on the storage medium.

9. The method of claim 7, further comprising the steps of:
recording each of the media objects being presented during the class session, that is not pre-stored on the storage medium; and
recording presentation information associated with each of the media objects being presented during the class session, that is not pre-stored on the storage medium;
wherein the table of contents further includes references to the media objects being presented during the class session, that is not pre-stored on the storage medium.

10. The method of claim 5, wherein the presentation information is provided from a super client who administers the class session.

11. The method of claim 5, wherein the presentation information includes timing information associated with presentation of each of the media objects during in the class session.

12. The method of claim 11, wherein the timing information includes information about start and stop time of the presentation of each of the associated media objects during the class session.

13. The method of claim 5, wherein the presentation information includes layout information associated with presentation of each of the media objects during the class session, the layout information specifying the relative position of the associated media objects on a display screen.

14. The method of claim 5, further comprising a step of generating a corresponding file based on the table of contents, which is executable to simulate the class session being presented, the corresponding file being based on one of the ECMA (European Computer Manufacturers Association)-script and XML (Extensible Markup Language).

15. The method of claim 5, wherein each of the references is a uniform resource locator (URL).

16. The method of claim 1, wherein the storage medium is an optic disc.

17. The method of claim 14, further comprising the steps of generating a media identification (ID) for each of the media objects being presented during the class session; wherein the table of contents further includes all the medium IDs associated with the respective media objects being presented during the class session.

18. A system for delivering a class session to students with client terminals in a virtual classroom, comprising:
means for interpreting operations performed at a super client terminal in accordance with a teacher's actions;
means for sending relevant commands and parameters based on the teacher's actions to client terminals to cause similar operations to be performed on the client terminals; and
means for controlling the students' experience relating to presentation of the media objects at the clients terminals, based on the operations performed at the super client.

19. The system of claim 18, wherein the operations performed at the super client terminal includes presenting media objects selected by the teacher, that are pre-stored on a storage medium.

20. A system for recording a class session in a virtual classroom, comprising:
means for recording selected media objects being presented during the class session;
means for recording presentation information associated with each of the selected media objects being presented during the class session; and
means for generating a table of contents containing all of the selected media objects being presented during the class session, along with the associated presentation information so as to allow the class session to be subsequently simulated in a desired order based on the table of contents.

21. A system for recording a class session in a virtual classroom, comprising:
means for generating a reference to each of selected media objects pre-stored on the storage medium, that is presented during the class session;
means for recording presentation information associated with each of the selected media objects; and
means for generating a table of contents containing the references to the selected media objects, along with the associated presentation information so as to allow the class session to be subsequently simulated based on the table of contents.

22. The system of claim 21, wherein the generating means generates a reference to each of media objects being presented during the class session, that is not pre-stored on the storage medium.

23. The system of claim 22, further comprising:
means for recording each of the media objects being presented during the class session, that is not pre-stored on the storage medium;
wherein the recording means records presentation information associated with each of the media objects being presented during the class session, that is not pre-stored on the storage medium;
wherein the table of contents further includes references to the media objects being presented during the class session, that is not pre-stored on the storage medium.

24. The system of claim 20, wherein the presentation information includes timing information associated with presentation of each of the media objects during in the class session.

25. The system of claim 20, wherein the presentation information includes layout information associated with presentation of each of the media objects during the class session, the layout information specifying the relative position of the associated media objects on a display screen.

26. The system of claim 20, further comprising means for generating a corresponding file based on the table of contents, which is executable to simulate the class session being presented, the corresponding file being based on one of the ECMA (European Computer Manufacturers Association) script and XML (Extensible Markup Language).

27. The system of claim 20, wherein each of the references is a uniform resource locator (URL).
